(19) United States
(12) Patent Application Publication
(10) Pub. No.: US 2004/0066791 A1
(43) Pub. Date: Apr. 8, 2004

(54) Asynchronous expansible switching system for switching packet with different length

(76) Inventors: Jingshown Wu, Taipei (TW); Kun-Tso Chen, Chanhua (TW); Hen-Wai Tsao, Taipei (TW); Ting-Yuan Wang, Taipei (TW)

Correspondence Address: BIRCH STEWART KOLASCH & BIRCH, PO BOX 747, FALLS CHURCH, VA, 22040-0747, US

(21) Appl. No.: 10/261,954

(22) Filed: Oct. 2, 2002

(51) Int. Cl. H04L 12/28

(52) U.S. Cl. 370/419; 370/394; 370/389

(57) ABSTRACT

An asynchronous expansible switching system for switching packet with different length mainly comprising a plurality of linecards, preprocessors, sequencers, switching planes and multiplexers and is able to provide an optional routing mechanism for a distributed packet, wherein the switch is able to expand the switching plane in accordance with the increase of the input port and the output port and transmit the packets within the buffering of the output port of the switching plane to the output port by the control of the preprocessor and the sequencer.

### BACKGROUND OF THE INVENTION

The invention is related to a configuration design for a packet switching system, especially to an asynchronous expansible switching system for switching packet with different length that can asynchronous process packet with different length.

So far the conventional switch was designed for processing each packet with the same length and all data-flow through the input port were required to be synchronous. In general, the switch can be distinguished into different types including: a switch with an input buffering, a switch with an output buffering and a switch with a hybrid input/output buffering respectively. The switch with an input buffering always gets extremely high blocking probability, and the configuration of switch with a hybrid input/output buffering is complicated and less for use. To prevent the blocking effect of head-of-line blocking effect and get high throughput and low packet loss, it is necessary to locate the output buffering of the switch on the output. Meanwhile, an internal transmitting speed of the switch must be several times of an external transmitting speed thereof so as to transmit numerous packets to the same output at the same time slot simultaneously. For the purpose of accelerating transmission, an access time for the data of the buffers must be shortening.

With rapid growing of Internet transmission and advancement of optical fiber communication technology, it is necessary to provide a switch with larger capacity. Because the highest internal transmitting speed of the switch is limited by hardware technology now, the switch is unable to the function of the buffer packet in its output. To prevent restriction of hardware speed, many kinds of methods appeared for improving efficiency of the switch under the configuration of buffering packets on its adopted input. However, these configurations must be possessed with a complicated switch control unit and thereby restricting the switches to be accomplished with high speed and large capacity. Therefore, to accomplish a switch with large capacity and low packet loss, the key point is to simply control the selection of the switch routing.

In addition, besides the complicated control unit, all inputs of the conventional switches are required to be synchronous. The requirement of synchronous circuit increases the cost of hardware and the delay time of packets when the switch is passing thereby. The routing control mechanism of the conventional switch is operating in the synchronous mode generally and then the loading of the synchronous mode of the switch is increasing. To process the packet with different length directly without segmenting them into small cells and reassembling therein, and to provide service conforming different types of data-flow, the switching packet is asked by the present Internet upper communication protocol for providing the different lengths of the packets. Therefore, the design for the switch in the next generation has to be processed with different lengths of the packets of directly. As for the design of the conventional switches, this requirement is highly increased the complication of the control unit thereof.

In the design of the conventional switch, the length of a packet is constant and all operations are synchronous. A central control unit is necessary for this design to arrange a packet schedule, i.e. setting the transmission time of each packet and the internal path of the switch. With the advancement of the line transmitting speed, the switch has become the bottleneck of Internet capacity now. Therefore, it is an important issue about how to improve the control mechanism of the switch. In addition, considerating the Internet system, the present switch is provided not only conventional function such as switching, but also has to be satisfied with the requirement of upper communication protocol toward quality of service.

At the same time, for transmitting packets over Internet protocol directly without segmenting them into cells with constant length and reassembling thereof, it is necessary to provided a switch that is able to process packets with different length directly. Thus, the conventional switches is unable to satisfy the requirement of large capacity and high quality toward optical fiber network in the future because of the restriction of complication of control circuit.

It is therefore tried by the inventor to develop a asynchronous expansible switching system for switching packet with different length so as to solve the problem of complicated control circuit under the condition of asynchronous packets of different length, thereby a switching element with module design is provided to be cooperated to a simple input controller so as to switch a switching system with different length packets asynchronously.

### SUMMARY OF THE INVENTION

It is the primary object of the present invention to provide an asynchronous expansible switching system for switching packet with different length that can asynchronously process packets of different length under a simply operable hardware configuration.

It is another object of the present invention to provide an expansible switch in accordance with the requirement of Internet toward gradually increase capacity of a switch so as to provide a switch system with module design to satisfy further needs.

To achieve the above and other objects, an asynchronous expansible switching system for switching packet with different length of the present invention is provided for use in the communication network, such as Packet Switching Network or Circuit Switching Network. It is functioned in that communication packets or data-flow of different routing in the input port is transmitted to the corresponding output port. The present invention can asynchronously process packets of different length and the core thereof is a multi-planed switching matrix, which mainly comprising,

1. a linecard for transferring IP address or the label of multiple protocol label switching inputted within a packet of a switch into the routing control data in need of operating a switch.

2. a preprocessor for transmitting the inputted packets to the buffer within different sequencers to wait for the following processes.

3. a sequencer for transmitting the packets orderly within the buffer thereof to a specific switching plane in accordance with the operation of the system.

4. switching planes wherein each of the switching planes is formed of a plurality of switching elements which is connecting in accordance with the types of matrixes. Each switching element is received the packet transmitted from the sequencer which is connected to the switching element and the routing status is changed by the input IP address to be “switching on” or “switching off” in accordance with the port address outputted from a destination en of the packet. If the switching element is in the condition of “switching on”, then packets transmitted from the sequencer will be transmitted to the buffering of the output port connected with the switching element. Oppositely, if the switching element is in the condition of “switching off”, then packets transmitted from the sequencer will be intercepted without transmitting into the buffering of the output port. Meanwhile, with the alarm sent by the output port busy indicator, the output conflict occurred when the switching element of the buffering of the output port connected with the same block is transmitted the can be prevented. In each individual operating mechanism of each switching element, each packet entered into the switching plane orderly can be transmitted to the buffering of the wanted output port without additional control.

5. a multiplexer located in front of each output port for transmitting the packets within the buffering of the output port of the switching plane to the output port.

The above-mentioned elements designed with special system configuration are using to get high throughput, low blocking probability and low packet loss probability. The input ports of the switching plane are able to share to the same number of the input ports by the collaboration of a preprocessor. Therefore, the number of the input ports of each switching plane can be lower than the number of the output ports thereof so as to obtain the low packet loss probability or the low blocking probability. In each switching plane, the timing that the packets of different input ports is entered into the switching plane are controlled by the sequencer and the output port busy indicator so that output conflict can be solved.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a diagram that shows the system configuration of the present invention;

FIG. 2 is a logic diagram that shows the switching plane of the present invention;

FIG. 3 is a diagram that shows the packet format of the present invention;

FIG. 4 is a diagram that shows the unicast packet format of the present invention;

FIG. 5 is a diagram that shows the multicast address packet format of the present invention;

FIG. 6 is a diagram that shows the multicast data packet format of the present invention;

FIG. 7 is a block diagram of the preprocessor of the present invention;

FIG. 8 is a circuit diagram that shows the switching matrix within the preprocessor of the present invention;

FIG. 9 shows the diagram of the controller of the preprocessor of the present invention when a status of the controller is changed;

FIG. 10 is a block diagram that shows the filter of the preprocessor of the present invention;

FIG. 11 is a circuit diagram that shows the hierarchical decoder of the preprocessor of the present invention;

FIG. 12 is a circuit diagram that shows the address decoder of the preprocessor of the present invention;

FIG. 13 is a circuit diagram that shows the buffer table of the preprocessor of the present invention;

FIG. 14 is a block diagram that shows the sequencer of the present invention;

FIG. 15 is a diagram that shows a status of the switching process unit of the present invention;

FIG. 16 is a block diagram that shows the virtual queues of the present invention;

FIG. 17 is a diagram that shows a status of the service buffer unit of the present invention;

FIG. 18 is a diagram that shows the truth table of priority comparator of the present invention;

FIG. 19 is a block diagram that shows the token passing line of the present invention;

FIG. 20 is a diagram that shows an operation of the token passing line of the present invention;

FIG. 21 is a logic diagram that shows the selective input controller of the present invention;

FIG. 22 is a diagram that shows a status of the condition of the selective input controller of the present invention;

FIG. 23 is a block diagram that shows the switching element of the present invention;

FIG. 24 is a logic diagram that shows the header trailer decoder of the present invention;

FIG. 25 is a logic diagram that shows the switching element controller of the present invention;

FIG. 26 is a logic diagram that shows the connector of the present invention;

FIG. 27 is a block diagram that shows the correlator of the present invention; and

FIG. 28 is a diagram that shows a status of the condition of the multicast correlator of the present invention.

### DETAILED DESCRIPTION OF THE PREFERRED EMBODIMENTS

The switch of the present invention is mainly using to process the selection and the switch of a routing of packets with different length, such as a maximum packet of IP can be 65535 bytes. Each packet can be considered as a series of bit stream. Although the switch of the present invention is employed in the packet switching network as the most important consideration, the switch can be applied on the circuit switching network. In the packet switching network, the function of the switch is to send each packet in the input port in order to arrive the wanted output port. Similarly, in the circuit switching network, the specific input port is able to be retained to a path of the output port by the switch so that the connecting session of communication can be established.

In addition, because the hardware of the switch is simple, especially the complexity of the control circuit is low, so as to satisfy the requirement of the simple control unit for a switch with fast and large capacity. Therefore the switch of the present invention can be practiced with the present integrated circuit technology. For illustrated purpose, it is exemplified to illustrate the practicality of the electric switch as the example to discuss the operation of the switch configuration and the detail functions of each device of the systems. Meanwhile, the switch of the present invention is not only lying in the packet switching network, but also with the same operations which can be applied to the corresponding circuit switching network.

The switch can be operated in the asynchronous mode, that is to say, packets transmitted form each input port can be transmitted to the switching matrix orderly without waiting for the regular organization completely. If the output port busy indicator of the switching element corresponded to the objective output port doesn't alarm, i.e. no packet is transmitting to the same output port at this time, then the packet is transmitted to the objective port by the switching element. Otherwise the packet is registered in the buffer for waiting to enter the switching matrix orderly. In the configuration of the present invention, the schedule of the central control unit for all routings of the packets is unnecessary, only a simple correlator circuit designed in the switching matrix element is able to achieve self-routing. Because the hardware of the control circuit needed by each switching matrix element is identical except the saved, compare to the central controller of the conventional switch, the design and the cost of the hardware of the switch can be greatly decreased.

A plurality of switching planes are employed for the core of the switch as the switching fabric. The configurations of each plane are the same and can be operated individually. For illustrated purpose, the number of the switching plane is referred to be P and the number of the input port of the switch is referred to be N. The consideration of conventional reliability is not the purpose of the switch for employing the switching planes for the core of the switch as the switching fabric, therefore there is no need to have many redundancy circuits. For providing better efficiency, the number of all input circuits provided by all switching planes are R times the number of the input ports of the switch, wherein R is an expansion ratio. Meanwhile, each switching planes has N output ports connected to the output port of the switch respectively.

Therefore, each switching plane is a

$$\frac{NR}{P} \times N$$

switching matrixes and the number of the input ports of each switching plane are much less than the number of the output ports thereof, so as to decrease the head-of-line blocking effect. Also, each switching plane is a switching matrix of

$$\frac{{N}^{2} R}{P}$$

cross point, thus the effectiveness of a hardware is enhanced.

Before entering into any switching plane, each packet has to be passed through a sequencer and is entered into a switching plane at an indicated time of the sequencer. In the meantime, several designated input ports of the switching plane are shared with several input ports by the coordination of a preprocessor. A buffer is provided in each output port of a switching plane for saving a packet transmitted from the input port of the switching plane. Finally, the packets with the same output ports in the buffer of the output of all switching planes are transmitted to the output lines orderly. Each switching plane is operated at the same speed of the input port and the output port without speed-up.

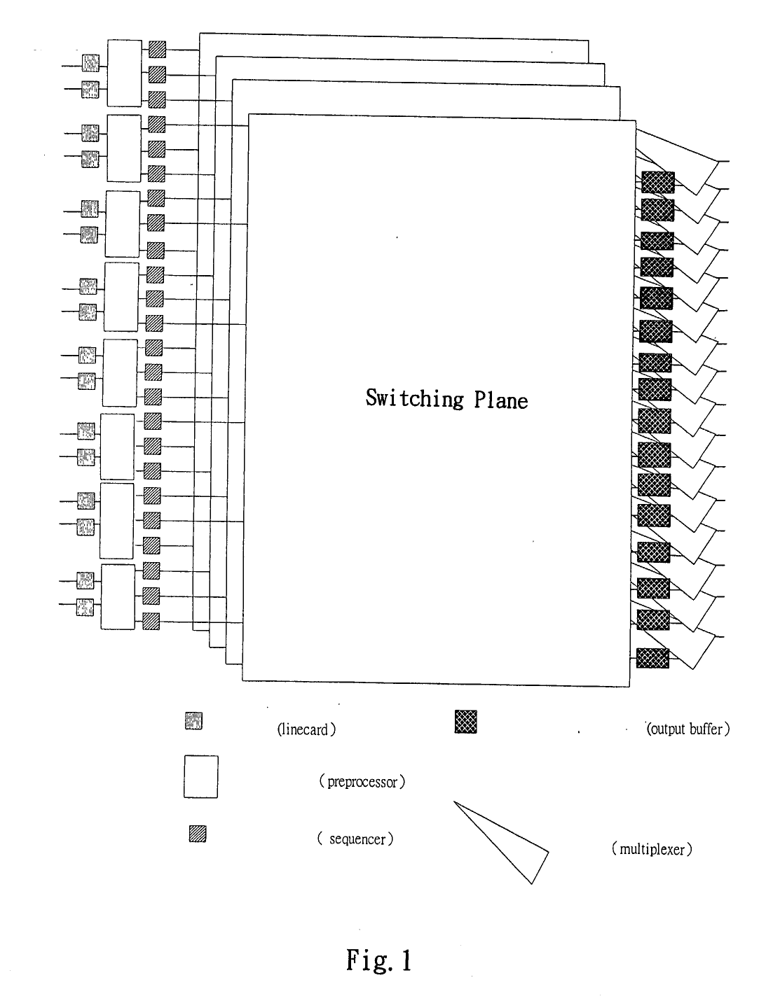

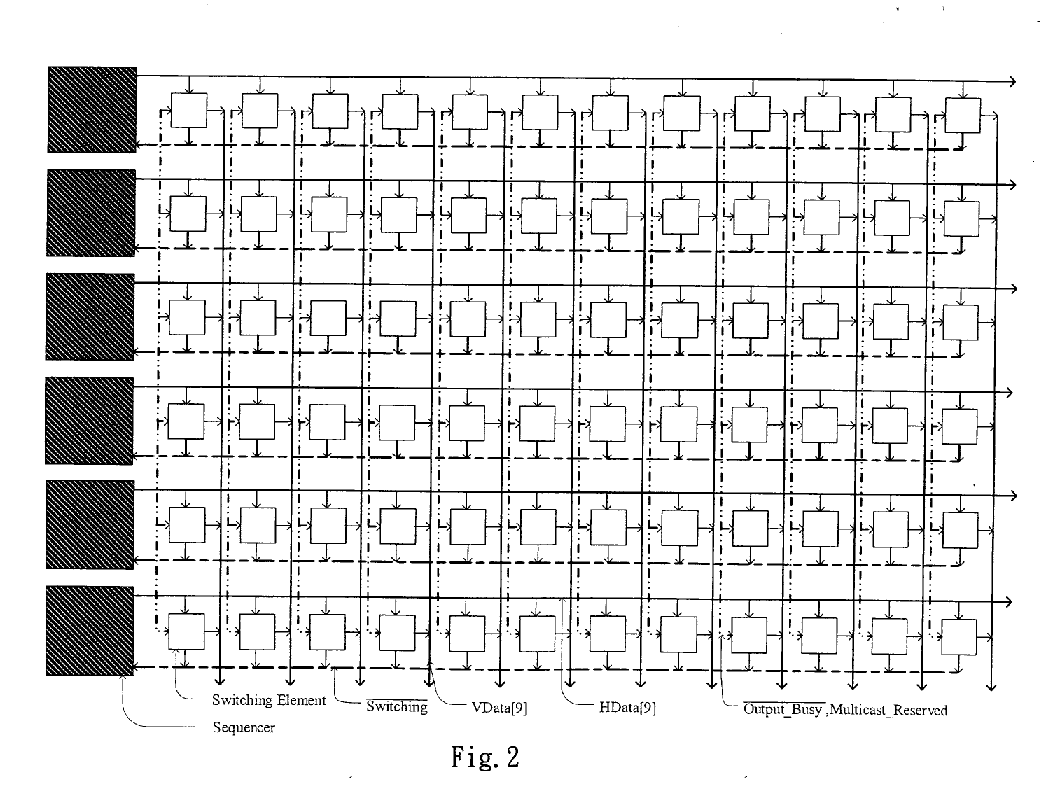

Please refer to FIG. 1 which is a diagram that shows the system configuration of the present invention. As shown, a switch is mainly formed of a plurality of linecards, preprocessors, sequencers, switching planes and multiplexers and is able to provide an optional routing mechanism for a distributed packet. Under the system configuration of the present invention, four switching planes of a 16×16 switching matrix are provided and the expanded proportion thereof is 1.5. Thus, a switching plane has a 6×16 switching matrix and three input port are shared to each two input ports of the switch, and therefore eight preprocessors is needed in total. The same switching plane is not necessarily shared to the same group of the sequencers. As shown in FIG. 2 that is a logic diagram of the switching plane, each switching plane is formed of a plurality of switching elements in accordance with the types of matrixes.

The linecard is provided as shown in FIG. 1 in which each input line is connected to a linecard. The functions of the linecard are including processing the transformation of the data format of the packet, determining the transferring output port of the packet via contrasting with the data of a check table and setting the address data of the output port. For matching up the operation of the switch, the tag information needed to be appended to the linecard is provided in the front port and the rear port of the packet. After the linecard is reading a header of the packet of the input line, the packet is decided to be a unicast packet or a multicast packet. If it is a unicast packet, then check the table to decide an output port address in which this packet is wanted to be reached. For example, in regard to ATM Internet, the header is solved by the linecard and a virtual path indicater in which the linecard is wanted to be reached is obtained thereafter. Then, the address of the output port of the switch is obtained by checking the table. If it is a multicast packet, then the linecard has to determine a group to which the packet belonged and check the table to fine a plurality of output port address in which this packet is needed to be transmitted. The packet entering to the switch is distributed into three types including a unicast packet, a multicast address packet and a multicast data packet. The unicast packet is including the contents of original packet and the transmitted output port address. The multicast address packet is including a plurality of output port address in which this multicast packet is transmitted. These addresses are indicated by a bit map, i.e. the number i bit is indicated whether the number i output port is belonged to one of the output port in which the packet is wanted to be transmitted. The multicast data packet is including the contents of original multicast packet. Because the switch is provided for processing the packets with variable lengths, so all lengths of the packets are variable.

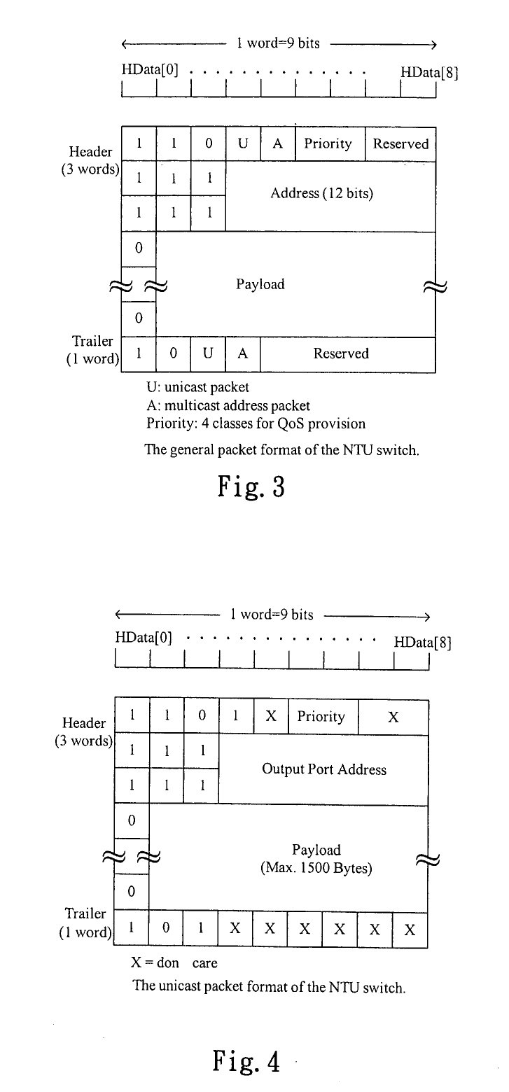

Please refer to FIG. 3 that is a diagram that shows the packet format switched by the linecard. As shown, in the switch, a word is nine bits Hdata [0] to Hdata [8]. When a word is the header or trailer of the packet, Hdata [0] is set to be 1. If the word is the data contents of the packet, Hdata [0] is designated to be 0. If the word is the portion of the header, Hdata [1] is designated to be 1; otherwise Hdata [1] is designated to be 0, the word is the trailer. As regards word of the header, if Udata [2] is set to be 0, then designate the first word and Hdata [2] of the other words are set to be 1. Depending on the number of the output port, a plurality of words of the header are using to represent the output port address. Field U and field A are used to designate the type of the packet. If field U is set to be 1, then the packet is a unicast packet. If field U is set to be 0 and field A is set to be 1, then the packet is a multicast packet. Field Priority with two bits is used to designate the priority of the packet for providing the quality of service. Field Priority has four degrees totally. 11 is the highest priority and 00 is the lowest priority. Field Address is used to designate an output port address of a unicast packet or a group address of a multicast packet. Field Payload is the contents of original packet or the bit table of the output port address of the multicast packet. Since the length of the packet is variable, the trailer is used to designate the end of each packet. Different types of the packets are used to define different trailer. Field is retained without using.

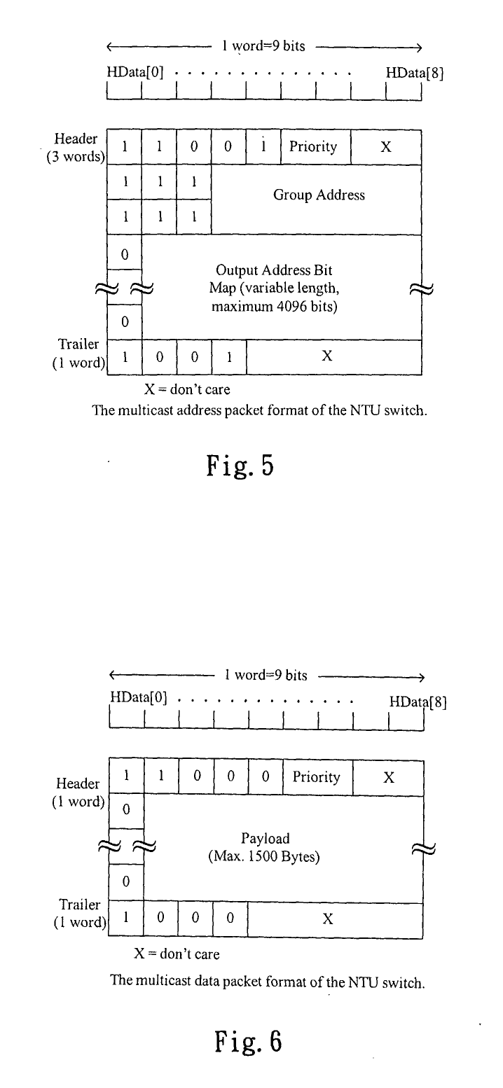

Please refer to FIG. 4 that shows the unicast packet format. In this example, two words of the header are used to be an output port address and are twelve bits. The longest length of the packet data is set to be 1500 bytes and it is the longest length of an Ethernet date. FIG. 2 and FIG. 3 show the format of a unicast address packet and the contents thereof are including a bit table with variable length in which the longest length is 4096 bit. FIG. 5 show the format of a unicast data packet and the longest length of the packet data is set to be 1500 bytes as well as the unicast packet.

After the above process, the entered packet is transmitted to usable switching planes and is able to reach the designated terminal by self-routing. Because a group of an input port of a switching plane is shared to a plurality of linecards, the packet has to be processed by a preprocessor before entering into the switching plane, as shown in FIG. 1. An input buffer is provided to the linecard for saving the packet to be processed.

The preprocessor is functioned to coordinate the same group of the linecards and effectively use the usable input port of the switching plane of the same group. As shown in FIG. 1, the input ports of the three switching planes are shared to each two linecards. This preprocessor is a 2×3 simple switching matrix and is connected to two linecards and three sequencers, wherein a service buffer is provided to each sequencer for saving the packet in the process of switching until the switching of the packet is finished. A queue is formed each priority degree singly and a packet of the degree is saved to each queue respectively. If a specific degree queue of the service buffer within the sequencer is not packed, the preprocessor is needed to inform the linecard. If the next packet of the inputted service buffer is belonged to the degree, this packet is transmitted to the queue.

Conventional switch has to maintain the transportation sequence of the packet, i.e. the packets from the same source and the path of the designated terminal have to obey the rule of first in first out. In the switch of present invention, the packet transmitted from the same linecard via the preprocessor is able to transmit into different switching plane for switching by several sequencers. A path is provided to each switching plane for each designated terminal. Therefore, the packet to be transmitted to the same designated terminal is able to reach the designated terminal via different switching plane. The impact of the packet is probably occurred in one switching plane, so that the time for the packet to reach the designated terminal is a random order service.

Therefore, the succeeded order of switching for the packet to be transmitted to the same output port in a linecard is not first in first out. Also, even the sequencer of the same switching plane, the packet thereof is not first in first out. Thus, when the packet of the linecard is switching to the sequencer by the preprocessor, the output port address of the designated terminal of the packet is necessary to be considered. If the packet of the input port is waiting to be switching in a specific sequencer connected to a preprocessor and the output port address of the designated terminal thereof is the same as the output port address of the designated terminal of the switching packet, then the preprocessor is able to transmitted this packet to the sequencer after it is left the sequencer. If the packet is a multicast packet, compare the address of the group and then transmit the packet to the sequencer after it is left the sequencer.

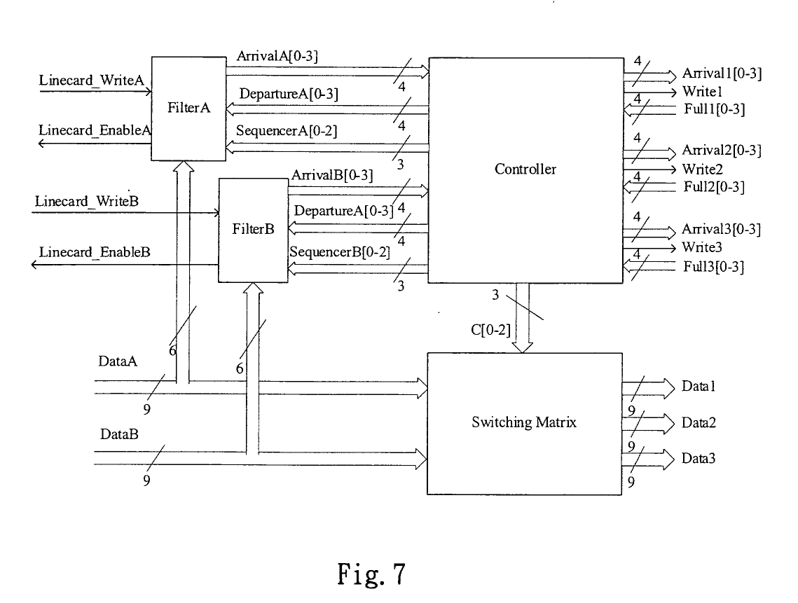

Please refer to FIG. 7 that is a block diagram of the preprocessor. A preprocessor is connected to three sequencers [0-2] from two linecards [A, B]. The linecard is informed the preprocessor that some packets are waiting for processing in the buffer of the input port of the preprocessor by a linecard_write of a control signal line. The preprocessor is informed the linecard by a linecard_enable and first transmitted the address of the designated terminal for judging the sequencer needed to be transmitted. After the sequencer needed to be transmitted is determined by the preprocessor and the status of switching matrix is set, then inform the linecard to transmitted the data of the packet to the corrected sequencer continuously by the linecard_enable. Data A and data B from the two linecards are switching to data 1, data 2 and data 3 of the three sequencers via the switching matrix.

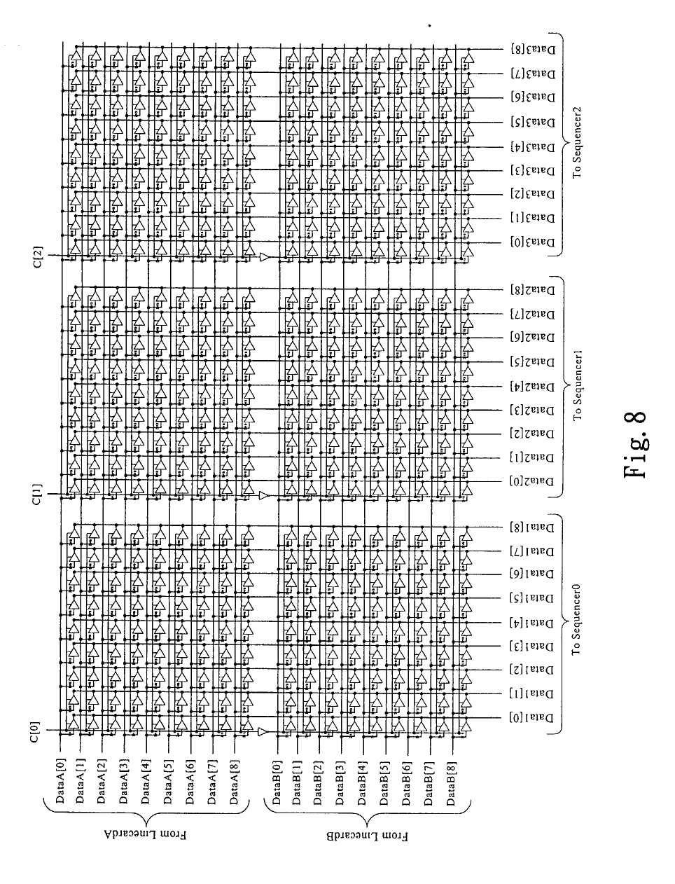

Please refer to FIG. 8 that is a circuit diagram of the switching matrix. control signal line C [0-2] select the linecard connected with each sequencer respectively. For example, when C [0] is logic 1, a linecard 1 is connected to a sequencer 0.

For satisfy the completeness of the switching order, the arrival of each packet is needed to pass a filter first so as to inform a controller at the correct time for changing the status of the switching matrix, as shown in FIG. 7. For each linecard, a filter is recorded the status of the packet from this linecard in the sequencer. If a packet is waiting for transmitting in some sequencer, then the packet arrived after and having the same address is needed to be transmitted to the sequencer after the sequencer is empty. Therefore, the filter is needed to check the address of the designated terminal of each arrived packet until no address of the packet is the same as the packet waiting in the sequencer so as to inform the controller of the arrival of the packet by Arrival [0-3] of the control signal line and select an unused sequencer to process this packet.

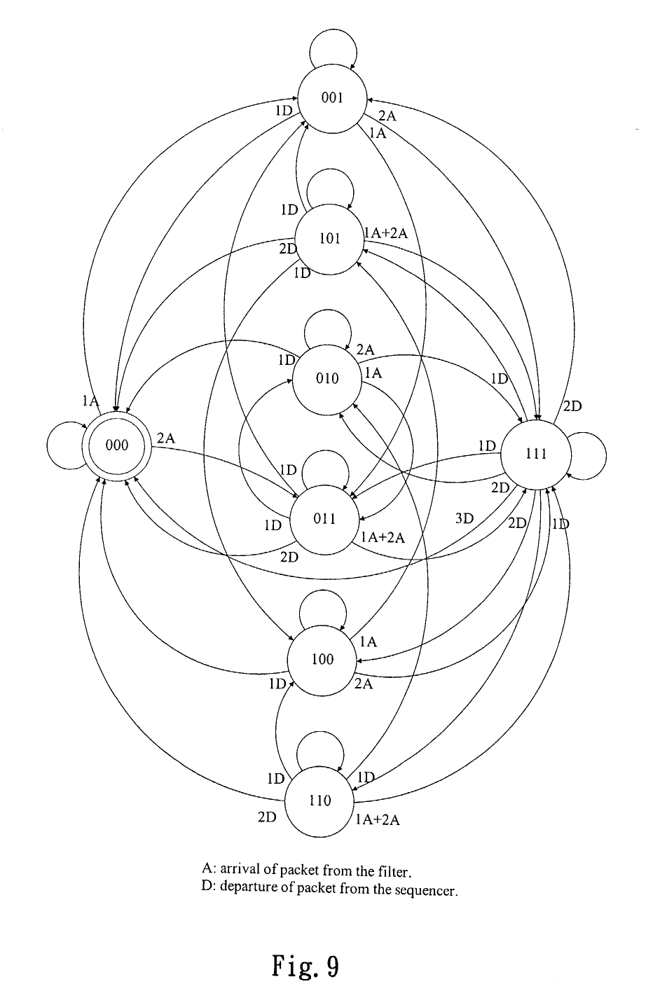

Please refer to FIG. 9 that is the diagram shown the change of the status for a finite state machine of the controller of the preprocessor. Since the system of the present invention is distributed the packet to four priority degrees, thus the controller is able to operate by distributing to be four degrees. FIG. 9 shows the diagram of the change status for some degree. Each status is (xyz) which is represented the status of the buffer of the degree in the sequencer. 0 is represented no packet, 1 is represented some packets are waiting for transmitting and (000) is the initial status. An affair A is represented the arrival of the packet from the filter by means of signal Arrival A and Arrival B. An affair D is represented the departure of the packet from the sequencer by means of signal Full 1, Full 2 and Full 3. As shown in FIGS. 7 and 8, when the packet is arrived, the empty sequencer is selected for transmitting this packet by the controller so as to change the control signal C[0-2] for controlling the status of the switching matrix and connect the linecard to the useable sequencer. Meanwhile, the linecard is informed for use such sequencer by the control signal line Sequencer A and Sequencer B and for the arrival of the packet from the sequencer by Arrival 1 or Arrival 2 or Arrival 3 and Write 1 or Write 2 or Write 3. If the number of the arrival of the packets are exceeded in the number of the usable sequencer, then it is selected to transmit the packets randomly. When the packet is left the sequencer then inform the filter by Departure A or Departure B. To simplify this design, if affair A and affair D are happened at the same time, process affair D first and then process affair A.

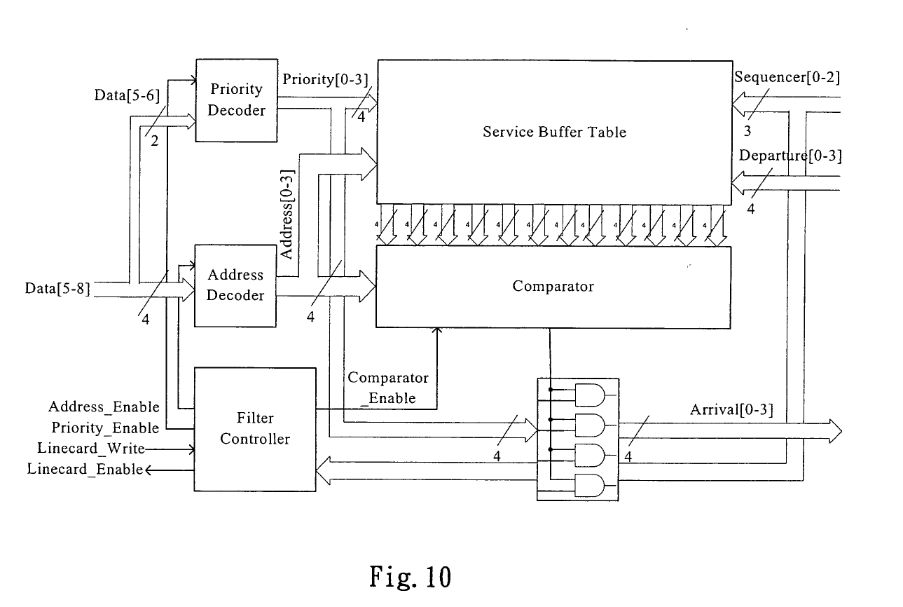

Please refer to FIG. 10 that is a block diagram of the filter, wherein a filter controller is a limited state machine. When the linecard is informed the arrival of the packet by Linecard Write, the filter controller is informed the linecard for transmit the data by Linecard_Enable. Then, the priority degree and the output port address of the designated terminal are read-out by switching on a Priority_Decoder and an Address_Decoder respectively. Thereafter, a comparator is switching on for comparing the contents of the buffer and the address of this packet so as to judge whether the packet with the same address is waiting for transmitting in the sequencer. If yes, then contiguously wait until no packet with the same address is waiting. At this time, an signal of the arrival is provided to the controller for informing the arrival of the packet. Then, the controller is transmitted the signal of the sequencer to the filter for informing the packet which is transmitted to the sequencer. Therefore, the process of the packet by the filter is finish, and thus the comparator is stopped.

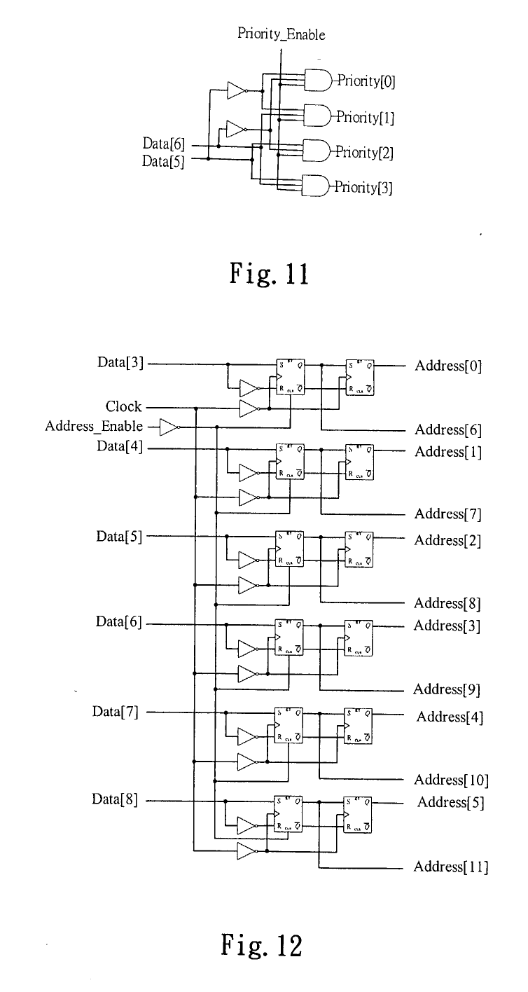

Please refer to FIGS. 11 and 12 that show a circuit diagram of a degree decoder and a address decoder respectively. In accordance with the packet format of the transmitted linecard, the degree decoder is using Data [5-6] and the address decode is using Data [3-8].

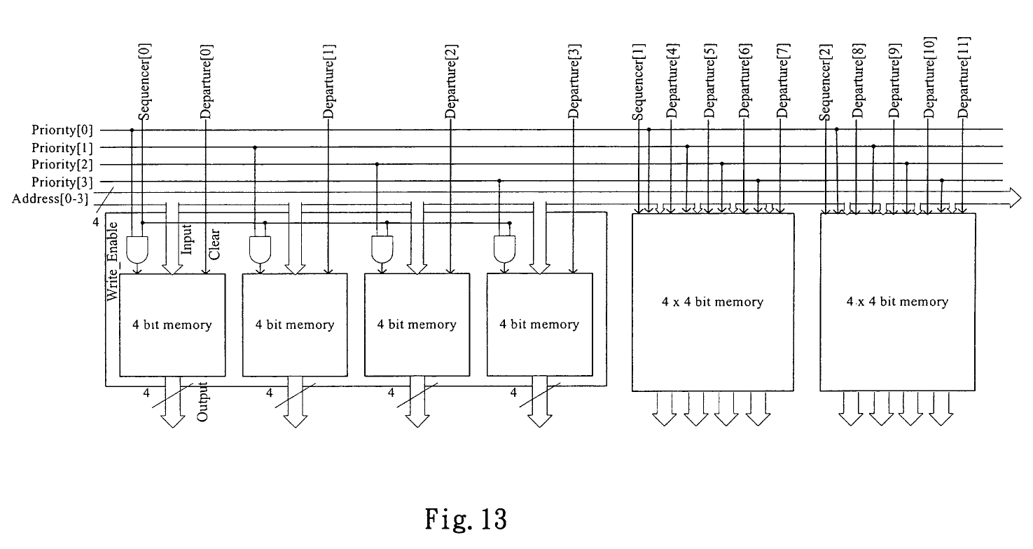

Please refer to FIG. 13 that is a circuit diagram of a service buffer table. The service buffer table is mainly comprised of memory which is recorded within three sequencers. There are four degree queues are the using status of the linecard. If the packet from the linecard is waiting for transmitting in the queue of some sequencer, then the designated terminal is recorded in corresponding table. Therefore, the table has twelve entries and each entry is recorded with the output port address of the designated terminal of the packet in the queue. Such as a 16×16 switch, the output port address of the designated terminal of the packet in the queue is four bits. Twelve output entries of this table are provided to the comparator for comparing. The input content of each entry is the designated terminal address of the packet, which is in the act of process by the filter. The position of the input entry is determined by the degree of the packet with corresponding to the controller for informing in which the packet is transmitted to the sequencer. The Write_Enable of the memory is controlled by priority [0-3] and sequencer [0-2] of the control signal line, and the writer content is controlled by the address [0-3]. In addition, when the packet is left the sequencer, the memory content of the corresponding sequencer entry is cleaned by departure [0-11] of the controller.

Each switching plane is connected to a plurality of sequencers and each sequencer has a service buffer for saving the packet transmitting from the preprocessor. Each switching plane is able to allow a plurality of packets to enter. In the meantime, since each output port is able to allow only one input port to be on-line in one switching plane, therefore when at least two packets are wanted to reach the same output port, an output conflict is happened. To solve the output conflict, the packet is able to enter the switching plane for switching in the allowable timing of the sequencer. Once the packet is entering to the switching plane, the packet is disseminated to a connected switching element simultaneously for processing a correlation test of the address.

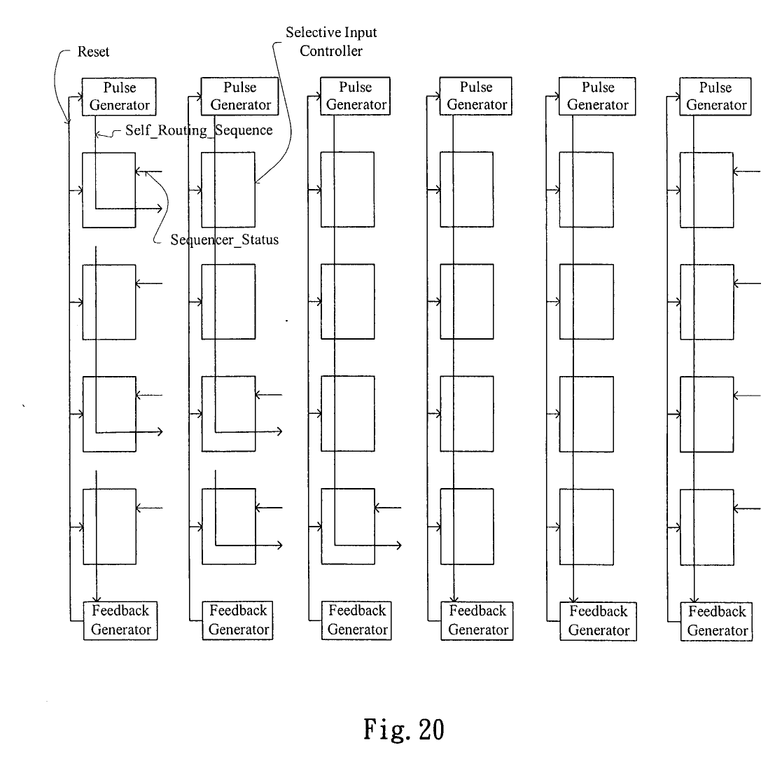

The sequencers connected to the same switching plane are able to input the packet within the service buffer to the switching via the timing a token passing line is occurred thereupon. A token pulse is provided to this token passing line and selectively transmitted to the sequencer of the same switching plane orderly. If the sequencer is not needed to input the packet into the switching plane, then the token passing line is transmitted the token pulse to the next sequencer. If the sequencer is needed to input the packet into the switching plane, then the token passing line is transmitted the token pulse to the sequencer for the timing the packet is started to transmit. Therefore, the sequencers, which is connected to the same switching plane and having packet wanted to input into the switching, are received the token pulses orderly and entered into the switching plane in turn. Please refer to FIG. 20 that is a diagram shown an operation of the token passing line, wherein four sequencers are connected to the same switching plane. Thus, four selective input controllers are provided to the token passing line and are connected to four sequencers respectively. A series of pulses are formed contiguously by a pulse generator in the beginning. Each pulse is used to be a token and is downloaded by Self_Routing_Sequence of the control signal line until a feedback generator is received the pulse and then a reset signal is sent to all selective input controllers and feedback generators, so as to reset the status to be the initial status. The feedback generator is restated to transmit a series of pulses after receiving this reset signal.

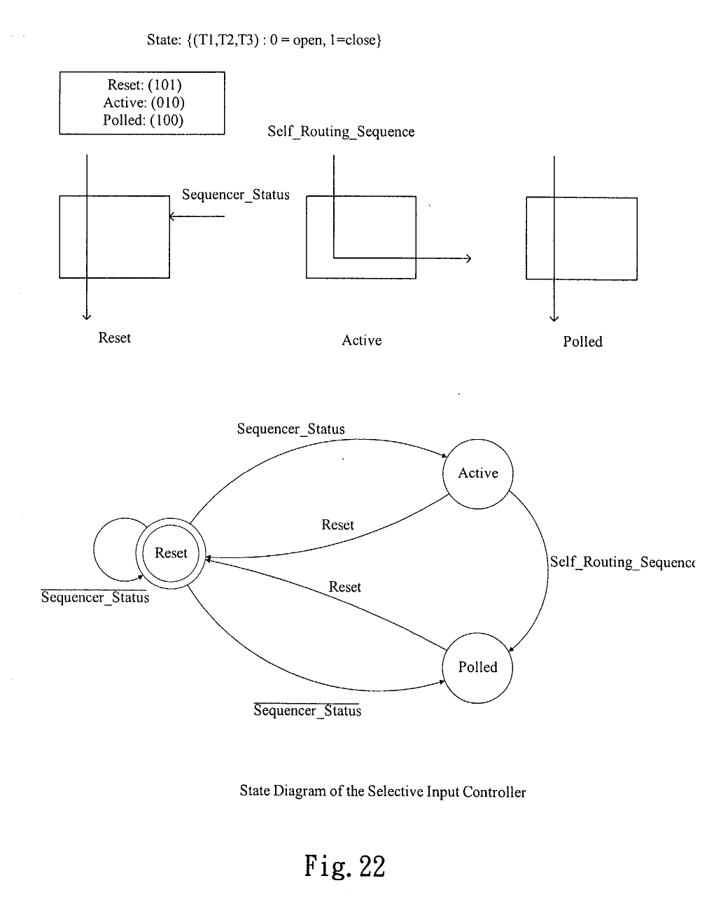

Please refer to FIG. 22 that shows the states of the selective input controller including a reset state, an active state and a polled state. In the reset state, the pulse is able to pass this selective input controller and the status of this selective input controller is able to change via sequencer_Status by the sequencer simultaneously. In the active state, the sequencer has the packet wanted to transmit to the switching plane. Therefore, the transmitting path of the pulse is changed by the selective input controller and the received pulse is transmitted to the sequencer but the next selective input controller. In the polled state, because the sequencer has been received the pulse, it is unable to change the selective input controller to obtain the pulse. Also, FIG. 22 shows the state diagram of the selective input controller.

In the beginning, the selective input controller is kept in the reset state. Before the pulse is arrived, the selective input controller is changed into the active state and waited the arrival of the pulse when the packet is transmitted to the sequencer. When the pulse is arrived, the pulse is transmitted to the sequencer and the selective input controller is changed into the polled state so as to directly transmit the later pulse to the next selective input controller. In the reset state, the sequencer is able to change the selective input controller to obtain the pulse. Once the pulse is arrived, in either event the sequencer has the packet which is wanted to be transmitted, the selective input controller will be in the poled state and is unable to transmit the pulse to the sequencer. Therefore, in one polling cycle, all sequencers will be polled one time and obtained a chance to transmit the packet into the switching plane. The polling cycle in FIG. 20 is shown the change status of the selective input controller.

In corresponding to the quality of service, this system of the present invention is distributed the packet to four priority degrees and each degree is able to save a packet in the service buffer of the sequencer. The packet with a highest degree at this time is selected to input into the switching plane by the sequencer. When a packet with a higher degree is arrived the service buffer, the packet is able to input into the switching plane after the processing packet is switched. Further, the sequencer in the same switching plane is needed to consider the priority degree of the packet and then decide whether the packet is able to be transmitted or not. In other words, as regards all packets wanted to be transmitted to the same output port, the packet with a higher degree is needed to be transmitted to the output port. Therefore, as regards all packets wanted to be transmitted to the same output port and existed in the same switching plane of all sequencers, only the packet with a highest degree is able to be input into the switching plane. The packet in the same switching plane of the sequencer is considered to be formed a plurality of virtual queues and the packet of each virtual queue is transmitted to the same output port. The service of the virtual queue is a non-preemptive priority queue. That is the packet with a higher degree is able to surpass the packet with a lower degree and is arranged in the preceding position and the packet with a higher degree is needed to be processed after the processing of the packet at this time is finished. The order of the packet with the same degree is a random order service. For the requirement of service quality, the virtual queue is provided to the sequencer for recording the status of all virtual queues belonged to the switching plane. When the sequencer is processed a packet, it is necessary to check the virtual queue so as to judge whether this packet is able to be inputted to the switching plane. Further, the sequencer is synchronously updated all statuses of the virtual queue in all sequencers by signal line Qos_line. For sharing this service quality line to all sequencers, another token passing line is added to provide a token pulse for the sequencers so as to use this signal line Qos_line orderly.

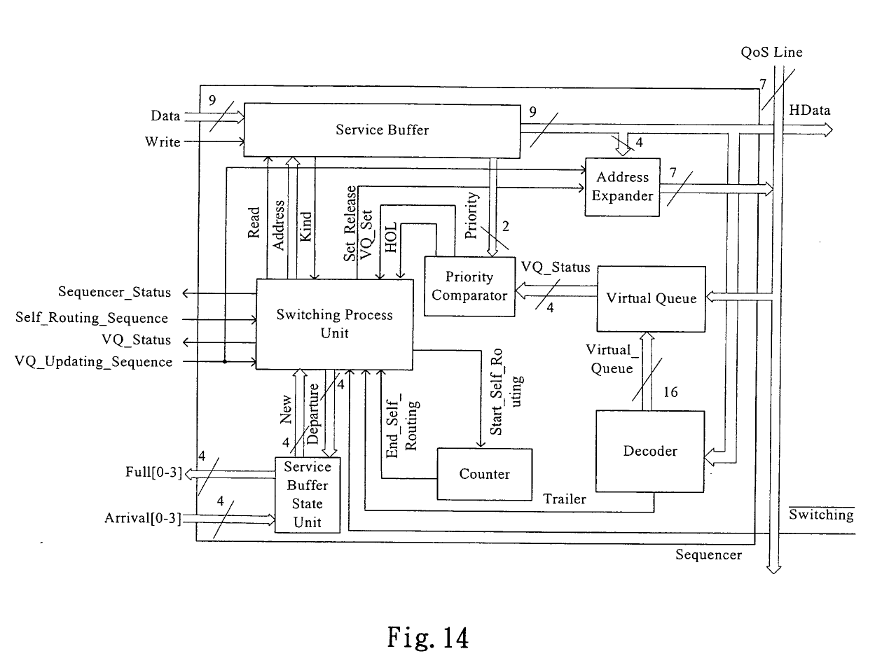

Next, the design of each portion of the sequencer will be described as follows. Please refer to FIG. 14 that is a block diagram of the sequencer. The sequencer is formed of three portions in accordance with its functions.

The first portion is saving the packet transmitted from the preprocessor and is including a service buffer and a service buffer state unit.

The second portion is in charge of the write and read of the virtual queue and is including a virtual queue, an address expander, a priority comparator and a decoder.

The third portion is in charge of inputting the packet into the switching plane and is updated the status of the virtual queue. It is including a switching process unit and a counter.

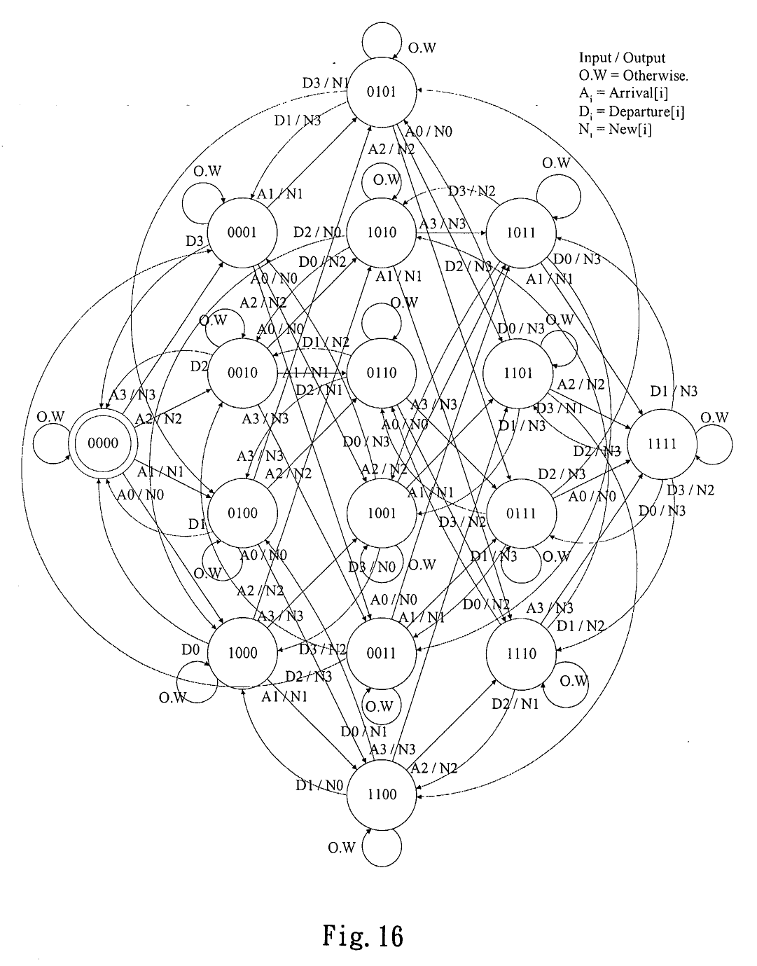

For saving the memory with the size of four packets in the service buffer, each priority degree is able to save one packet. When there are packets in the preprocessor is wanted to be transmitted to the sequencer, the service is informed by the control signal line write and the data is wrote from the data line. The data is transmitted by a data bus with 9 bits in width. The status of the service buffer is recorded by the service buffer state unit, i.e. whether a packet is saved in each degree at this time. The service buffer state unit, i.e. the present status, is informed the preprocessor whether a packet is saved in each service buffer at this time by the control signal line full[0-3]. The preprocessor is informed the service buffer state unit about the arrival of the packet of each degree by the control signal line arrival[0-3]. Once the packet in the service buffer is processed by the switching process unit, the switching process units informed the service buffer state unit about the departure of the packet by the control signal line departure [0-3]. Please refer to FIG. 16 that is the status of the service buffer state unit. Each status is shown by (X₀X₁X₂X₃). If Xi is 0, then it is means there is no packet with i priority degree. If Xi is 1, then it is means there is a packet with i priority degree, wherein degree 0 is the lowest degree. Affair Ai is means that the preprocessor is informed the service buffer state unit by the control signal line arrival[i] when the packet of i degree is arrived the sequencer. Affair Di is means that the switching process unit is informed the service buffer state unit by the control signal line departure[i] when the packet of i degree is arrived the sequencer. Affair Ni is means that the service buffer state unit is informed the switching process unit by new[i] when the new packet is processing. If a plurality of packets are the sequencer simultaneously the service buffer state unit is informed the switching process unit to process the packet with a highest degree. After the packet is processed, the switching process unit is informed the service buffer state unit about the departure of the packet. Therefore, even the packet arrived the service buffer is prior to the packet under processing with higher degree, this packet with higher degree is needed to wait for processing until the processing of the switching process unit is finished. In accordance with this rule, the status of the finite state machine of the switching process unit is able to illustrated and designed.

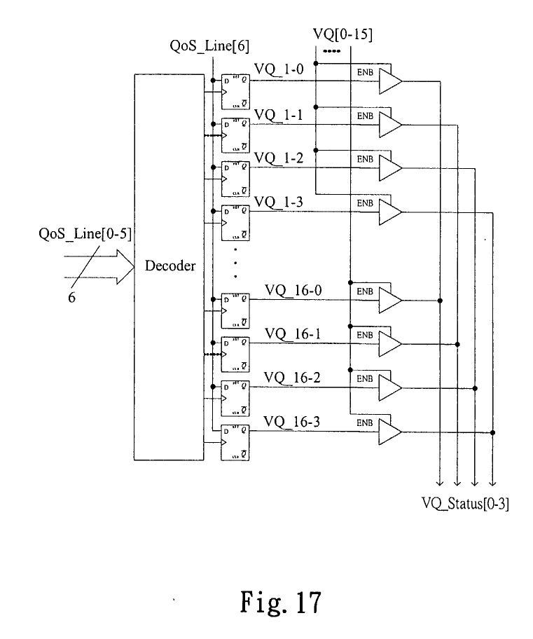

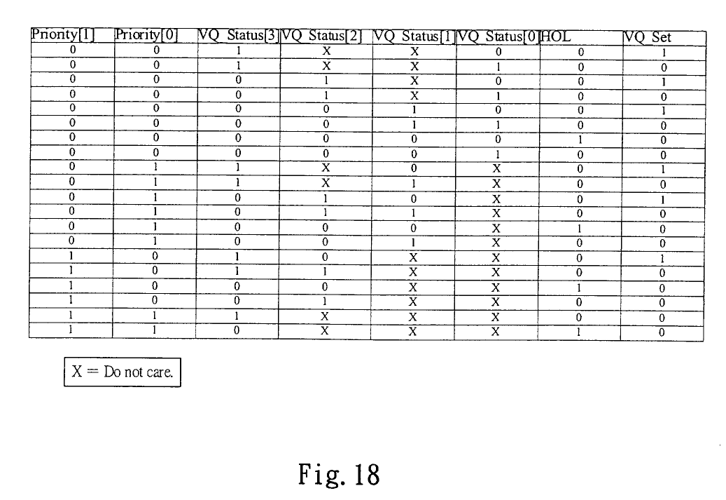

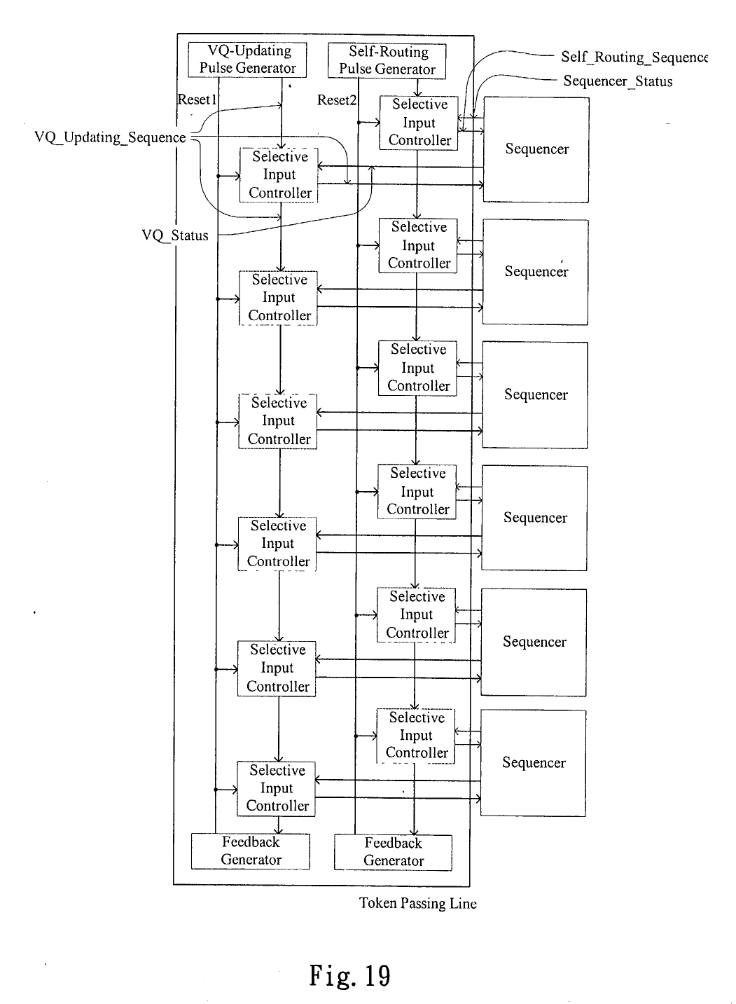

There are sixteen output ports in a 16×16 switch. Therefore, the packet in the sequencer of the same switching plane is formed in sixteen virtual queues. Each virtual queue has four priority degrees and each degree of each virtual queue is needed to be recorded whether there are the packets are waiting for inputting into the switching plane. Thus, sixty-four D flip-flops are used for the virtual queue. The switching process unit is only needed to check the virtual queue and then is able to decide if the packet under processing is allowed to input into the switching plane. The switching process unit is needed to check without stopping until there are no packet with higher degree is existed in the switching plane, then the packet is able to input into the switching plane. The switching process unit is inputted the output port address of the packet processing at this time, i.e. the virtual queue belonged to the packet, by the control signal line Virtual_Queue[0-15] . As shown in FIG. 17, the output control signal line Vq_Status[0-3] is represented if there are packets are waiting for inputting in the four degrees of the virtual queue. The priority degree comparator is compared the degrees of the outputted packet and the packet processing at this time so as to decide whether the packet processing at this time is able to be inputted into the switching plane. A output HOL of the priority degree comparator is represented that this packet is the highest degree in the virtual queue so as to input it into the switching plane. Further, The priority degree comparator is informed the switching process unit to update the status of the virtual queue. When the packet is found that the virtual queue therein is existed the packet with higher priority degree and the packet with higher priority degree prior to this virtual queue is not exist, then the status of this degree of this virtual queue is needed to be updated into the status in which the packet is waiting for inputting. A true table is used to defined the priority degree comparator. As shown in FIG. 18, priority is the priority degree field in the header of the packet under processing. The sequencer of the same switching plane is including the same virtual queue unit and is updated synchronously by the control signal line Qos_line. Qos_line[0-6] is including a priority degree with 2 bits, an output port address with 4 bits and a signal line for setting the contents of the flip-flops. When the flip-flops is wrote, the input signal line Qos_line is needed to be took out from the output port address in the packet and the flip-flops are needed to be decided to set or reset at the same time. An address expander is provided for the transformation of this format. Since sequencer of the same switching plane is shared with the same signal line Qos_line, in order to prevent from the conflict, the token pulse is provided for the address expander via a control signal line Vq_Updating_Sequence so as to use as the Qos_line. Therefore, each switching plane has two token passing lines and a token pulse is produced respectively so as to decide the order of the sequence to input the packet into the switching plane and the order of the sequence to use the Qos_line. Before the packet is transmitting to the switching plane, the decoder is read the output port address of the packet so as to decode the located Virtual_Queue of the packet. When the packet is transmitting, the decoder is in charge of judging the trailer of the packet and informing the end of the packet to the switching process unit.

The switching process unit is the core of the sequence for controlling the time the packet is entering into the switching plane.

The switching is processed two kind of packets including the unicast packet and the multicast packet.

If the packet is a unicast packet, check the located virtual queue of this packet until this packet is the highest degree and then wait for the next token pulse so as to input the packet into the switching plane. If the packet is not a unicast packet and the degree the packet belonged is existed no packet in the virtual queue, then set the status of the located virtual queue of this packet belonged to the degree of the packet is logic 1 so as to show the packet is waiting for transmitting.

After the packet is inputted to the switching plane, judge whether the packet is able to be transmitted successfully to the output port via the switching element after a fixed period of time. If yes, the switching process unit is reset the located virtual queue of this packet belonged to the degree of the packet is logic 0 and is continuously transmitted the packet until the end of the packet. In the transmitting of the packets, the virtual queue is continuously checked by the other waiting packet and is updated its status. Thus, when the transmitting of the packets is finished, the next transmitting packet will still be the packet with a highest degree. If the length of the packet is not long enough so that the waiting packet in the sequence is unable to update the virtual queue completely, then resulted in the packet with a lower degree is found to be a packet with a highest degree and is thus inputted into the switching plane. For saving this problem, the packet is needed to make sure it is the packet with a highest degree in the present virtual queue for twice times and then is able to be inputted into the switching plane. If it is unable to be switching successfully, it is means there are some packet is switching into the output port. At this time, the switching process unit is set the status of the located virtual queue of this packet belonged to the degree of the packet is logic 1 and the virtual queue is checked until the packet is able to be inputted therein.

The present switching process unit is not considered the priority degree of the multicast packet. The priority degree of the multicast packet is only processed by the service buffer state unit. The multicast packet is including the address packet and the data packet. The switching process unit is waiting the token pulse to transmit the address packet first and then transmit the data packet at the next token pulse. All switching elements wanted to received this multicast packet are informed to transmit this packet by the multicast address packet when it is in the idle time. If the switching elements of this multicast packet is unable to transmit this packet, the switching process unit will be informed thereby and the switching process unit will be transmitting contiguously until the packet has been successfully transmitted by all switching elements. To prevent the multicast data packet from conflict, the sequence is still needed to transmit the packet orderly.

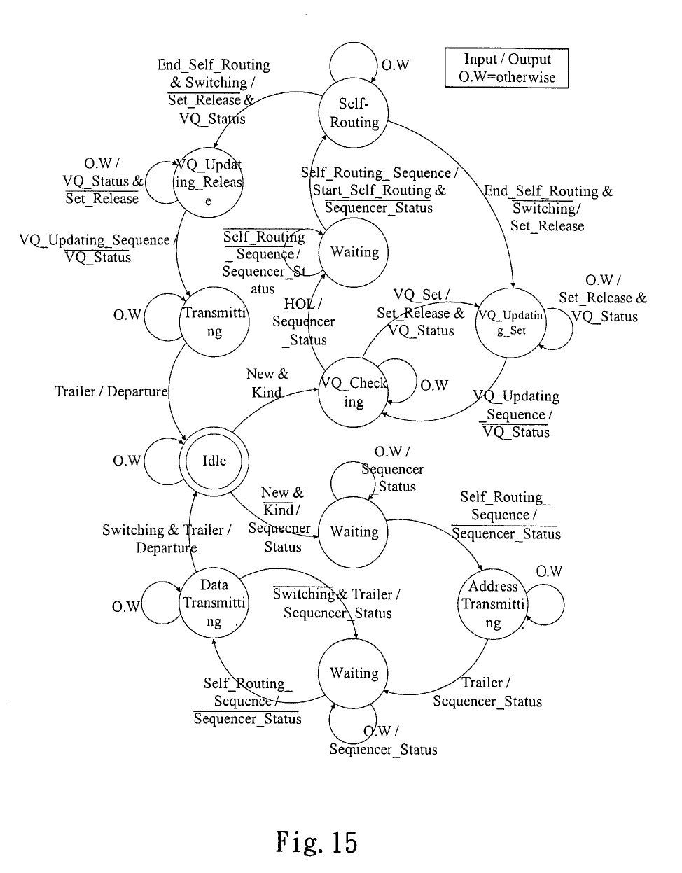

Please refer to FIG. 15 that shows a status of the switching process unit. After the packet is transmitted to the service buffer of the sequence by the preprocessor, the service buffer is considered the priority degree of the packet so as to inform the switching process unit the next packet to be processed by the control line signal new[i] . Further, the field U in the packet is checked via the control line signal kind by the switching process unit so as to decide the type of the packet. If it is the multicast packet and kind is logic 0, then set the control line signal sequence_Status is logic 1 and enter the status of waiting so as to get the token on the token passing line. When the token is arrived from a signal line Self_Routing_Sequence, then transmit the multicast address packet until the signal line trailer is logic 1, i.e. the trailer of the packet. Next, enter the status of waiting similarly, then transmit the multicast data packet. When the transportation of the data packet is finish, i.e. the signal line trailer is logic 1, then check whether the switching elements of the group has been successfully transmitted, i.e. the signal line switching is logic 1. If no, enter the status of waiting, then transmit the data packet again. If is a unicast packet, i.e. the signal line kind is logic 1, then enter the status of Vq_Checking and check the located virtual queue of this packet by the priority degree comparator. If it is necessary to update the status of the virtual queue, i.e. the signal line Vq_Set is logic 1, then enter the status of Vq_Updating_Set. When the signal HOL is set to be logic 1 by the priority degree comparator, it is means the degree of the packet in the virtual queue is the highest. Therefore the packet is able to be transmitted to the switching plane and is entering into the status of waiting for waiting the token pulse. When the token pulse is arrived, i.e. the signal line Self_Routing_Sequence is logic 1, then transmit this unicast packet and enter the status of Self_Routing. The required time of this status is fixed and the required time for transmitting the portion of the header of the packet is counted by the signal Start_Self_Routing starting the counter. After the transportation is finish, i.e. the signal end_Self_Routing is logic l,judge whether the packet is successfully switched by the switching elements. If the result of the status Self_Routing is unable, i.e. the signal switching is logic 0, then enter the status of Vq_Updating and update the virtual queue, and return to the status of Vq_Checking and recheck the virtual queue. If signal switching is logic 1, then enter the status of transmitting for transmitting the packet contiguously and update the virtual queue for setting the status of the degree in corresponding to the located Virtual_Queue of this packet is existed no packet so that the other packets with lower or equal priority degrees are able to be transmitted. After it is transmitted to the trailer of the packet, the processing of the packet is finished. At this time, the service buffer state unit is informed that the packet is left for the service buffer by the signal departure[i]. The switching process unit is informed token passing line to transmit the required pulse of Qos_line by signal Vq_Status and is set the logic value of the signal Set_Release simultaneously so as to decide the status of the degree in the virtual queue. Signal read and signal address are using for reading the data in the buffer and is inputting the data into the switching plane via a data line Hdata. When the packet is connected to the sequence in the same switching plane, the packet is needed to be inputted into the switching plane in order to prevent the packet from conflict when it is switching therein. Therefore, a self-routing token pulse is needed to be provided and only the sequence caught the self-routing token pulse is able to input the packet into the switching plane, as shown in FIG. 20. Further, a Qos_line is provided for these sequences to update the status of the virtual queue synchronously. Thus, a vq-updating token pulse is needed to be provided for coordinating the use of the Qos_line. The token pulse is transmitted to the sequence via signal line Self_Routing_Sequence and Vq_Updating _Sequence. The operation of the token passing line is shown as FIG. 20, wherein the key element is a selective input controller.

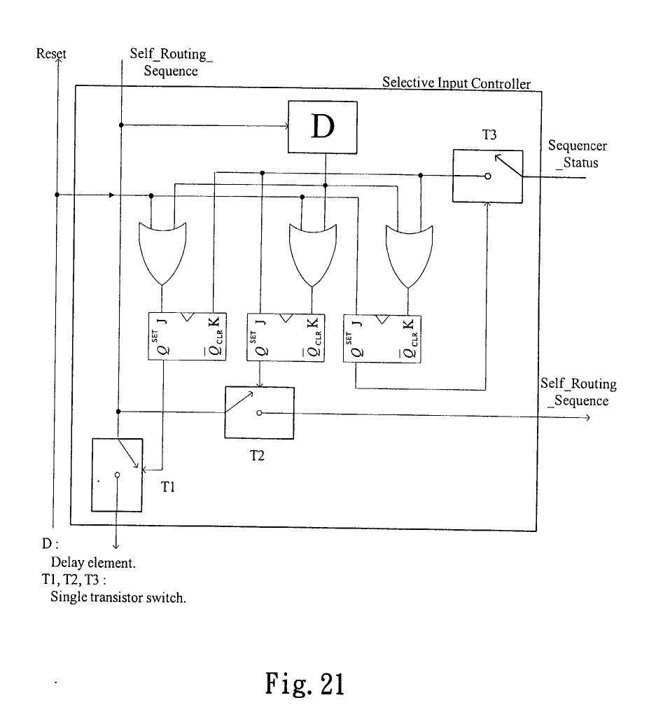

Please refer to FIG. 21 that is a logic diagram of the selective input controller and FIG. 22 is shown the state of the selective input controller controlled by three single transistor switch.

The core of the switch is formed of a plurality of switching plane. As shown in FIG. 2, each switching plane is connected

$$\frac{NR}{P}$$

sequence to N output port buffer. Each switching plane is formed of a switching matrix of

$$\frac{{N}^{2} R}{P}$$

switching element. Each sequence is distributed the packet to a row of switching element via the data line Hdata. Each field of switching element is able to transmit the packet to the corresponding output port buffer via the data line Hdata. To prevent from the output conflict, only a switching element of each field is able to use VData. The status of the switching element is able to be switching on or switching off. Each switching element is checked the output port address of the packet inputted from the sequence in corresponding to the using status of the field so as to decide if the packet will be transmitted to the output port buffer. In the status of switching on, the switching element is transmitted the data (Hdata) from the sequence to the lower level (VData). In the status of switching off, the switching element would not transmit the data (Hdata) from the sequence to the lower level (VData). Each field has an Output_Busy of the output port busy indicator for indicating if the corresponding data line VData is under using. Before the status of the switching element is changed from switching off to switching on, it is necessary to identify that the VData is unused for transmitted the other packets to the output port. Thus, a center control unit has no need. The configuration of each element is the same and the self-routing is made by simple circuit. Therefore, the cost will be lower and the practicability will be higher.

The switch element is processed to three types including a unicast packet, a multicast address packet and a multicast data packet. The type of the packet is shown as FIG. 3 and the format of the packet is able to define for judging the header of the packet. The length of all packets is variable. The length of the trailer is able to provide by decoding so as to judge the trailer of different types of the packet. As regards the multicast packet, the sequence is transmitting the multicast address packet first. Besides the warning signal Output_Busy of the output port busy indicator, each field of the switching element is shared a control signal line Multicast_Reserved. This control signal line is means that at least a switching element is prepared to transmit the multicast data packet.

When the switching element is received the multicast address packet, the multicast address packet is read for decide if this multicast packet is arrived the output port connected to the switching element. If yes, then set the field of this data line Multicast_Reserved is logic 1 until the multicast data packet is transmitted successfully and forbid the field of this data line VData to be used for other the unicast packet. In the meantime, the switching element is able to receive the multicast data packet which will be transmitted to the sequence. When this multicast data packet is arrived, the switching element is checked if an Output_Busy of the output port busy indicator of the field is logic 1. If no other packet is using the data line VData of the field, then set the Output_Busy of the output port busy indicator of the field to be logic 1 and set the status of the switching element is open so as to transmit this multicast data packet. Also, set a signal Switching to be logic 1 and inform the sequence that the multicast data packet is transmitted successfully. Otherwise set the signal Switching to be logic 1 and inform the sequence the multicast data packet is unable to be transmitted successfully. The sequence is needed to be waited until the signals Switching of all switching elements are logic 1, and then the repeat transmission of the multicast data packet is finished. When the multicast data packet is arrived the switching element, the located field of the switching element is possible to be idle or transmitted one packet, or wait the multicast data packet which is held before transmitting. Because all packets are entering into the switching plane orderly, so no conflict will be happened. However, the multicast data packet is needed not only to wait the transmission of the transmitting unicasts to be finished, but also wait the transmission of the other multicast data packets and then is started to be transmitting. When the transmission of the multicast data packets are finished, the output control signal Output_Busy and Multicast_Reserved is logic 0.

When the sequence is inputted the unicast, the header of this packet is including the output port address to be transmitted. Once the packet is entering into the switching element, the decoding action is processing immediately so as to decide whether the data line VData of the located field of the switching element is used. As soon as the output port address of the designated terminal of the packet and the address code existed in the switching element in advance are the same and no engaged signal Output_Busy of the output port (Output_Busy is logic 0) and no multicast data packets are reserved for the field (Multicast_Reserved is logic 0), then the status of the switching element is changed to be open, thereby this packet is started to be transmitting and the engaged signal Output_Busy of the output port is set to be logic 1 so as to prevent this output port is used by the other packet in the rear. When the switching element is detected the trailer of the packet, it is necessary to be returned to the close status and set the signal Output_Busy of the output port to be logic 0 so as to provide the data line VData of the field for the packet in the rear. If the packet is fail after the switching element is finished the choice self-routing because the data line VData connected to the output port address of the designated terminal is occupied, the packet is needed to be switched at the beginning of the next indicated timing until the switching is successful.

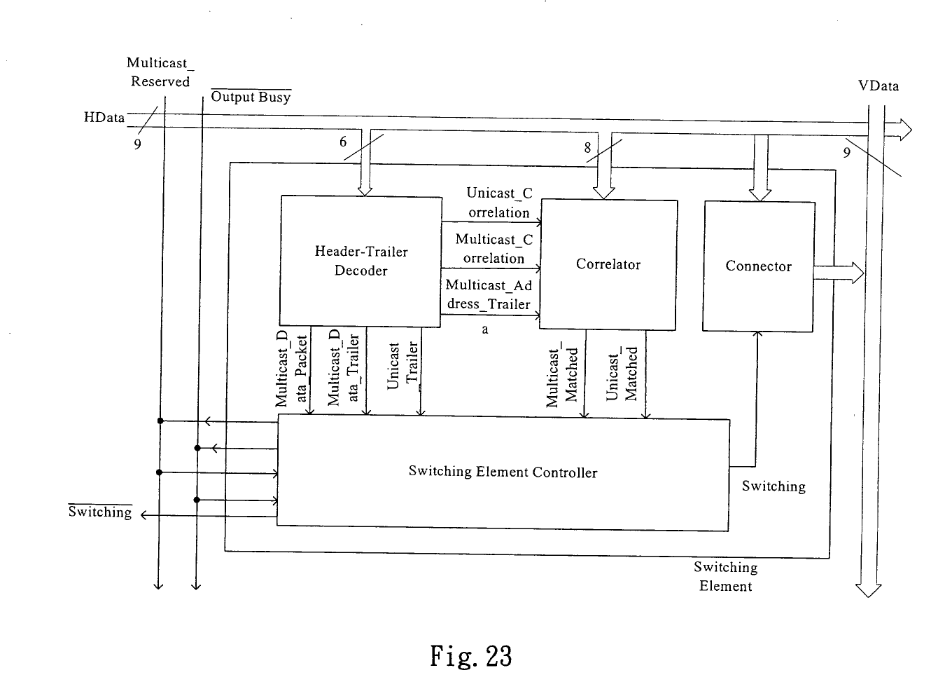

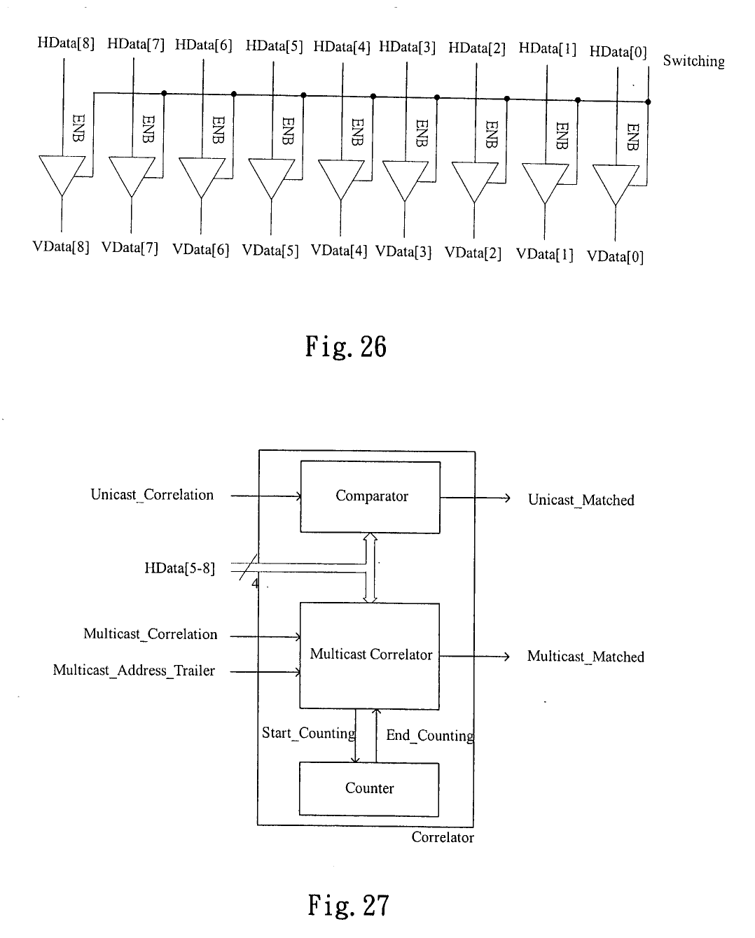

Each switching element is needed to check the output port address for the arrived data bus. Please refer to FIG. 23 that is a block diagram of the switching element, wherein the bus HData (9 bits ) is the data of the sequence and the bus VData (9 bits ) is the data of the output port outputted from the switching element. As shown in FIG. 26, when the status of the switching element is open (signal Switching is logic 1), the connector is transmitted the data of the VData to the VData. The status of the switching element (signal Switching) is decided by a switching element controller, as shown in FIG. 25. Two JK flip-flops are used by the switching element controller for controlling the signal Switching and the signal Multicast_Bit. When the switching element is belonged to the multicast group defined by the arrived multicast address packet, i.e. a signal Multicast_Matched is logic 1, then a signal Multicast_Bit is set to be 1. When the transmission of the multicast data packet is finish, i.e. a signal Multicast_Data_trailer is logic 1, then a signal Multicast_Bit is set to be 0. Multicast_Bit, the status of the switching element in the same field, is connected to a signal Multicast_Reserved of the field (Wired-OR). When the switching element is used the data line VData, the signal Output_Busy of the output port of the VData is logic 1, so an Output_Busy is the negative logic of the signal Switching. The negative logic of the Output_Busy, the status of the switching element in the same field, is connected to a signal Output_Busy* (Wired-AND). As shown in FIG. 25, the status of the switching element is changed into two possibilities which are including the transmission of the unicast packet and the transmission of the multicast packet, so as to start the connector. When the output port address of the unicast packet and the pre-saved address of the switching element are the same (a signal Unicast_Matched is logic 0) and no packet is using the VData in the field at that time(the signal Output_Busy is logic 0), then the connector is started, i.e. the signal Switching is set to be logic 1. When the multicast data packet is arrived the switching element, i.e. the signal Multicast_Data_Packet is set to be logic 1 and, this switching element is held by the multicast address packet of the multicast data packet (the signal Output_Busy is logic 0) and no packet is using the VData in the field at that time (the signal Output_Busy is logic 0), then the connector is started. Correspondingly, when the transmission of the unicast is finish or the transmission of the multicast data packet is finish, the status of the switching element is needed to be changed into close status, i.e. resetting the signal Switching to be logic 0.

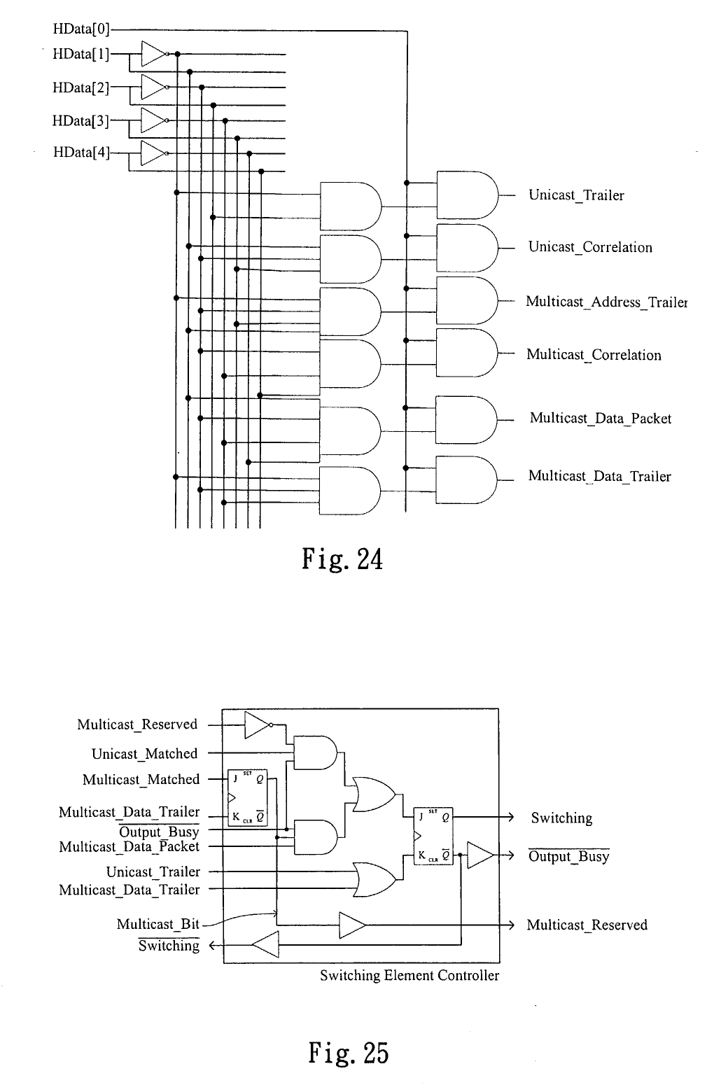

The types of all packet and the beginning and ending of the packet are defined in the format of the packet. In the meantime, according to this definiens, a header trailer decoder is able to read the data on the Hdata, as shown in FIG. 24. When the header of the unicast packet is arrived, a correlator is informed to judge whether the output port address of the designated terminal of the unicast packet and the pre-saved address of the switching element are the same. If yes, the signal line Unicast_Matched is outputted to the switching element controller by the correlator. The header trailer decoder is informed the switching element controller the ending of the packet by the signal Unicast_Matched. The header trailer decoder is informed the correlator the beginning and the ending of the multicast address packet by the signal line

Multicast_Correlation and Multicast_Address_trailer so as to judge whether the switching element is belonged to the group defined within this multicast address packet. If yes, the correlator is informed the switching element controller by the signal line Multicast_Matched. The header and trailer of the multicast data packet are then informed to the switching element controller by the signal line Multicast_Data_Packet and Multicast_Data_trailer respectively.

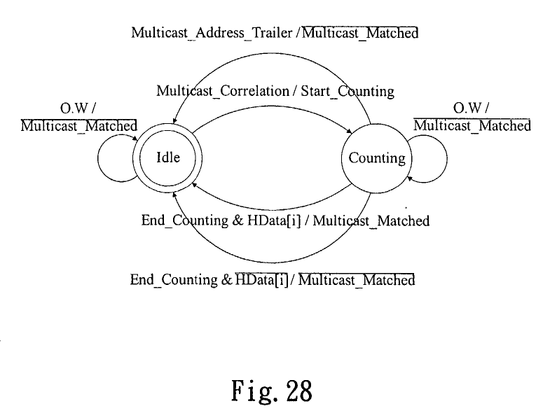

Please refer to FIG. 27 that is a block diagram of the correlator. The header data of the unicast packet is needed to be processed by the correlator. When the Unicast_Correlation is logic 1, the comparator is started. Since a 16×16 switch are exemplary in this embodiment, so the output port address is using 4 bits, i.e. Hdata[5-8]. Compare to Hdata[5-8] and the pre-saved address, if both of them are the same, then output signal Unicast_Matched. When the multicast address packet is arrived, the multicast correlator is checked whether the multicast packet address bit map of this packet is including this switching element, as shown in FIG. 28. When the multicast address packet is arrived and the signal line Multicast_Correlation is logic 1, then the counter is started by the signal Start_Counting and entering into the counting status from the idle status until the position of this switching element in the address bit map of this multicast address packet is counted (signal End_Counting) and then judge whether the signal Hdata[i] is indicated to be logic 1. If yes, then the signal line Multicast_Matched is logic 1. If the multicast address packet is finished without counting the located position of the switching element, i.e. the signal line Multicast_Address_trailer is logic 1, then it is means the switching element is not in the group of this multicast address packet. Therefore, the signal line Multicast_Matched is outputted to be logic 0 and return to idle status.

The packet is arrived the buffer of the output port via the switching matrix. Each output port has a corresponding buffer in each switching plane. Therefore, there is a need to have a multiplexer for transmitting the packets within these buffers to the output line.

With the above arrangements, the switch of the present invention has following advantageous features:

1. the switch of the present invention is no needed to be processed the packet with different length directly without segmenting and reassembling.

2. the switch of the present invention is able to be operated asynchronously without aligning the packet of each input port by synchronous circuit.

3. the switch of the present invention is including a optional routing mechanism without controlling each switching element and each input port by the complete central controller.

4. all elements are modular so as to add the element properly and thus expand the size of the switching.

5. the circuit hardware of each element is the same, it is suitable for the manufacture of IC.

6. each element is able to operate and control independently, thus this design is simple.

7. the switching is able to obtain a high capacity and a high throughput without the accelerating transmission of the hardware.

8. the switching is able to employ in Packet Switching Network or Circuit Switching Network.

9. the switching is able to process the packet with different priority degree so as to achieve the requirement of quality service.

10. the switching is able to provide the function of multicast.

It is not intended, however, that the invention is limited to the particular embodiments described or to use in connection with the apparatus illustrated herein. Various modifications and alternative embodiments such as would ordinarily occur to one skilled in the art to which the invention relates are also contemplated and included within the meaning and range of equivalents of the appended claims.

What is claimed is:

1. Asynchronous expansible switching system for switching packet with different length mainly comprising a plurality of linecards, preprocessors, sequencers, switching planes and multiplexers and is able to provide an optional routing mechanism for a distributed packet, wherein
the linecard is connected to a input line and is transferring IP address or the label inputted within a packet of a switch into the routing control data in need of operating a switch, and then is outputted into the preprocessor;.
the preprocessor is used for transmitting the inputted packets from the lincard to the buffer of its output port within different sequencers and waiting for the following processes.
the sequencer is connected to the output port of he preprocessor for transmitting the packets within the buffer orderly to a specific switching plane in accordance with the operation of the system so as to control the timing of the packet or data-flow entering into the switching plane;
the switching planes wherein each of the switching planes is formed of a plurality of switching elements which is connecting in accordance with the types of matrixes. Each switching element is received the packet transmitted from the sequencer which is connected to the switching element and the routing status is changed by the input IP address to be “switching on” or “switching off” in accordance with the port address outputted from a destination en of the packet and is saved the packet into the output port buffer of the output port;
the multiplexer is located in front of each output port in the switching plane for transmitting the packets within the buffering of the output port of the switching plane to the output port;
by virtue of this arrangement, the switch is able to expand the switching plane in accordance with the increase of the input port and the output port and transmit the packets within the buffering of the output port of the switching plane to the output port by the control of the preprocessor and the sequencer.

2. The asynchronous expansible switching system for switching packet with different length as claimed in claim 1, wherein the switch is able to process a unicast packet and a multicast packet.

3. The asynchronous expansible switching system for switching packet with different length as claimed in claim 1, wherein the switch is including the preprocessors which are less or equal the number of the input ports and the number of the connected linecards of the input ports of the preprocessors are less or equal the number of the sequencer connected to the input ports so as to transmit the packet in the linecard to the idle buffer of the sequencer for waiting the switching of transmitted switching plane.

4. The asynchronous expansible switching system for switching packet with different length as claimed in claim 1, wherein the number of the input ports of each switching plane equals the number of the sequencer connected to the output ports/input ports of the preprocessors divided by the number of the linecards and then multiplied by the input ports of the switch in number and finally divided by the switch planes in number.

5. The asynchronous expansible switching system for switching packet with different length as claimed in claim 1, wherein the number of the input ports of the sequencer equals the number of the sequencer connected to the output ports/input ports of the preprocessors divided by the number of the linecards and then multiplied by the input ports of the switch in number.

6. The asynchronous expansible switching system for switching packet with different length as claimed in claim 1, wherein the number of the input ports of the switch equals the number of the input ports of the preprocessors multiplied by the switching planes in number.

7. The asynchronous expansible switching system for switching packet with different length as claimed in claim 1, wherein the switching planes in the output port buffer is belonged to the same output port of the switch and is able to shared with the same multiplexer so as to connect to the corresponding output port of the switch, thereby the packet of the output port buffer is transmitted to the output line orderly.

8. The asynchronous expansible switching system for switching packet with different length as claimed in claim 1, wherein each linecard is accepted the packet on the input line and the data of the header thereof is checked by contrasted the internal data so as to find the output port address and the service quality priority degree of this packet and the types of the packet is belonged to the unicast or the multicast.

9. The asynchronous expansible switching system for switching packet with different length as claimed in claim 8, wherein the linecard is plus the header control data in front of the packet and this packet is transmitted by the data bus with a width of nine bits in the switch, i.e. one word is nine bits.

10. The asynchronous expansible switching system for switching packet with different length as claimed in claim 8, wherein each word is plus a bit for indicating whether the word is the control data of the header or the data of the packet.

11. The asynchronous expansible switching system for switching packet with different length as claimed in claim 9, wherein the first word of the word in the header control data is logic 1, the second word in the first header word is logic 0 and the second word in the other header words is logic 0.

12. The asynchronous expansible switching system for switching packet with different length as claimed in claim 11, wherein the header control data is including a service quality priority degree field, address field, and U bit field and A bit field for indicating the types of the packet.

13. The asynchronous expansible switching system for switching packet with different length as claimed in claim 12, wherein if the U bit of the header control data is logic 1, then this packet is a unicast packet; if the U bit of the header control data is logic 0, then this packet is a multicast packet.

14. The asynchronous expansible switching system for switching packet with different length as claimed in claim 13, wherein if the header control data is a unicast packet, then the address field is the output port address of this packet and this packet data is the original packet data.

15. The asynchronous expansible switching system for switching packet with different length as claimed in claim 13, wherein if the header control data is a multicast packet, then when the field A is logic 1, this packet is a multicast address packet and this packet is a multicast data address.

16. The asynchronous expansible switching system for switching packet with different length as claimed in claim 15, wherein if the header control data is a multicast packet, then when the address field the address of the multicast group and the packet data is including the bit map for showing the member of the multicast group.

17. The asynchronous expansible switching system for switching packet with different length as claimed in claim 15, wherein if the header control data is a multicast packet, then the head data is unable to have the address field and the packet data is the original packet to be transmitted.

18. The asynchronous expansible switching system for switching packet with different length as claimed in claim 9, wherein the trailer control data is using for indicating the ending of the packet and its first bit is logic 0.

19. The asynchronous expansible switching system for switching packet with different length as claimed in claim 18, wherein the trailer control data is including U bit field and A bit field for indicating the types of the packet. When U is logic 1, then it is indicating the ending of the unicast packet. When U is logic 0 and A is logic 1, then it is indicating the ending of the multicast address packet. When U is logic 0 and A is logic 0, then it is indicating the ending of the multicast data packet.

20. The asynchronous expansible switching system for switching packet with different length as claimed in claim 3, wherein each preprocessor is judged whether the buffer is idle or busy by the packet connected to the linecard and is switched the packet connected to the linecard into the idle buffer connected to the sequencer.

21. The asynchronous expansible switching system for switching packet with different length as claimed in claim 20, wherein each preprocessor is including a controller and a switching matrix.

22. The asynchronous expansible switching system for switching packet with different length as claimed in claim 21, wherein the switching matrix is connected the data lines of a plurality of the linecards to the data lines of a plurality of the sequencers.

23. The asynchronous expansible switching system for switching packet with different length as claimed in claim 21, wherein the controller is used for change the status of the switching matrix so as to transmit the packet of the linecard to the buffer in the sequencer.

24. The asynchronous expansible switching system for switching packet with different length as claimed in claim 3, wherein each preprocessor is including a plurality of the filters and the filters are connected to the linecards respectively.

25. The asynchronous expansible switching system for switching packet with different length as claimed in claim 24, wherein the linecard is informed the filter for the input of the packet and the filter is checked the output port address or the multicast group address of the packet so as to compare whether the saved packet address is came from the same linecard in the sequencer connected to the preprocessor and inform the preprocessor the arrival of the packet until no packet address is the same.

26. The asynchronous expansible switching system for switching packet with different length as claimed in claim 5, wherein the sequencer is including a service buffer for saving the packet transmitted from the preprocessor and each priority degree is able to save at least one packet.

27. The asynchronous expansible switching system for switching packet with different length as claimed in claim 5, wherein the sequencer is including a switching process unit and the packet is transmitted into the switching plane according to the calculation until the packet is transmitted successfully.

28. The asynchronous expansible switching system for switching packet with different length as claimed in claim 5, wherein each sequencer is including a virtual queue for each output port and each priority degree is recorded whether the packet is waited for transmitting in the sequencer connected to the same switching plane.

29. The asynchronous expansible switching system for switching packet with different length as claimed in claim 5, wherein if the processed packet is the multicast packet, then the step of the calculation for processing the packet by the sequencer is including:
A. waiting until the allowing timing and then transmitting the multicast address packet to the switching plane until the ending of the packet;
B. waiting until the allowing timing and then transmitting the multicast data packet to the switching plane until the ending of the packet;
C. if the switching plane is informed the multicast address packet that the output port is unable to receive this packet, then process the step B or finish the process of this packet.

30. The asynchronous expansible switching system for switching packet with different length as claimed in claim 27, wherein if the processed packet is the unicast packet, then the step of the calculation for processing the packet by the sequencer is including:
A. checking the virtual queue belonged to this packet according to the output port address of this packet and checking whether this packet is the highest priority degree; if yes, then wait until the allowing timing and transmit this packet to the switching plane; if not and this packet is the only packet having the priority degree, then process the step C or repeat this step;
B. if this packet is unable to be transmitted successfully, then process the step C; if this packet is able to be transmitted successfully, then change the contents of the priority degree belonged to the virtual queue of this packet for setting no packet is existed in the switching plane and transmitting the packet contiguously until the end, and finish the process of this packet;
C. changing the contents of the priority degree belonged to the virtual queue of this packet for setting the packet is existed in the switching plane and transmitting the packet contiguously until the end, and then return to the step A.

31. The asynchronous expansible switching system for switching packet with different length as claimed in claim 5, wherein the sequencer connected the same switching plane is using a token passing line to decide the order of the sequencer for transmitting the packet into the switching plane.

32. The asynchronous expansible switching system for switching packet with different length as claimed in claim 31, wherein the token passing line is including a pulse generator, a feedback generator and a plurality of selective input controllers and the number of the selective input controllers equal the number of the input port of the switch divided the sequencers and finally divided by the switch planes in number.

33. The asynchronous expansible switching system for switching packet with different length as claimed in claim 32, wherein serial pulses are provided by the pulse generator and each pulse is considered to be a token until a feedback signal is provided by the feedback generator again, then the other serial pulses is provided by the pulse generator

34. The asynchronous expansible switching system for switching packet with different length as claimed in claim 32, wherein the selective input controller is able to transmit the received token to the connected sequence as the timing allowing the packet to enter the switching plane or is transmitted the received token to the next selective input controller directly.

35. The asynchronous expansible switching system for switching packet with different length as claimed in claim 32, wherein the feedback signal is provided for the pulse generator and the selective input controller to reset the status thereof to be the initial status by the feedback generator.

36. The asynchronous expansible switching system for switching packet with different length as claimed in claim 34, wherein the states of the selective input controller are including a initial status, a grab status and a polled status.

37. The asynchronous expansible switching system for switching packet with different length as claimed in claim 36, wherein the pulse is allowed to pass through the selective input controller in the initial status and is allowing the status of the connected sequence to be changed to the grab status so as to obtain the token.

38. The asynchronous expansible switching system for switching packet with different length as claimed in claim 36, wherein the pulse is transmitted to the connected sequence by the selective input controller in the grab status.

39. The asynchronous expansible switching system for switching packet with different length as claimed in claim 36, wherein the pulse is passing through the selective input controller directly in the polled status and it is unable to change the status of selective input controller.

40. The asynchronous expansible switching system for switching packet with different length as claimed in claim 36, wherein the selective input controller is in the initial status at the beginning of the system or the time for receiving the feedback signal and when the packet in the connected sequence is transmitting to the switching plane, the entering to the grab status; when the token is passing through thereby, then entering to the polled status.

41. The asynchronous expansible switching system for switching packet with different length as claimed in claim 40, wherein the selective input controller is in the grab status, after the token is received and is transmitted to the connected sequence, the selective input controller is entering to the polled status.

42. The asynchronous expansible switching system for switching packet with different length as claimed in claim 40, wherein the selective input controller is entering to the initial status after receiving the feedback signal.

43. The asynchronous expansible switching system for switching packet with different length as claimed in claim 40, wherein when the selective input controller is in the polled status, the selective input controller is entering to the initial status after receiving the feedback signal.

44. The asynchronous expansible switching system for switching packet with different length as claimed in claim 32, wherein the selective input controller is including three transistor switches, three JK flip-flops, a delay element and three or logic gates.

45. The asynchronous expansible switching system for switching packet with different length as claimed in claim 32, wherein the status of three transistor switches are decided via the status of three or logic, a delay element and gates three JK flip-flops by the status signal of the connected selective input controller, the token pulse and the feedback signal.

46. The asynchronous expansible switching system for switching packet with different length as claimed in claim 32, wherein three transistor switches are T1, T2 and T3; T1 is used for deciding whether the token pulse is passing to the next selective input controller, T2 is used for deciding whether the token is transmitting to the connected sequence, and T3 is used for deciding whether the connected sequence is able to change the status of the selective input controller.

47. The asynchronous expansible switching system for switching packet with different length as claimed in claim 46, wherein T1 and T3 are set to be the close status and T2 is set o be the open status when the selective input controller is in the initial status.

48. The asynchronous expansible switching system for switching packet with different length as claimed in claim 46, wherein T1 and T3 are set to be the open status and T2 is set o be the close status when the selective input controller is in the grab status.

49. The asynchronous expansible switching system for switching packet with different length as claimed in claim 46, wherein T2 and T3 are set to be the open status and T1 is set o be the close status when the selective input controller is in the polled status.

50. The asynchronous expansible switching system for switching packet with different length as claimed in claim 5, wherein one token passing line is shared with the sequences connected to the same switching plane so as to decide the order for the sequence to use the a service quality line and update the status for the status in the virtual queue of all sequences.

51. The asynchronous expansible switching system for switching packet with different length as claimed in claim 4, wherein the number of the switching elements in each switching plane equal the number of the input port divided the sequencers and then divided by the linecards and finally divided by the switch planes in number, and connect the obtained switching element to be a matrix type.

52. The asynchronous expansible switching system for switching packet with different length as claimed in claim 51, wherein each row of the switching element is connected to the same sequence and each field of the switching element is connected to a output port buffer.

53. The asynchronous expansible switching system for switching packet with different length as claimed in claim 51, wherein each field of the switching element is provided with an output port busy device for indicating the corresponding output port is occupied.

54. The asynchronous expansible switching system for switching packet with different length as claimed in claim 51, wherein each field of the switching element is provided with an output port busy device for indicating the corresponding output port is retained for the use of the multicast packet.

55. The asynchronous expansible switching system for switching packet with different length as claimed in claim 51, wherein each row of the switching element is used a responded signal for informing whether the connected sequence is transmitting the packet.

56. The asynchronous expansible switching system for switching packet with different length as claimed in claim 51, wherein a multicast indicated device is provided in each switching element for indicating the packet which is needed to receive the multicast data packet arrived in the future.

57. The asynchronous expansible switching system for switching packet with different length as claimed in claim 51, wherein the switching element is compared the output port address to the unicast; if the output port address thereof is the same as the pre-saved address and the output port busy device connected to the switching element is in a idle status, then this packet is transmitted to the output port buffer connected thereof and the output port busy device is set to be a busy status, otherwise the responded signal is transmitted for informing the sequence that this packet is unable to be transmitted to the designated terminal thereof.

58. The asynchronous expansible switching system for switching packet with different length as claimed in claim 51, wherein the switching element is decoded the output port address of the multicast address packet; if the pre-saved address is provided in this multicast address packet, then the multicast indicated device is set to be logic 1 and a multicast retained device of the located field of the switching is set to be in a retained status.

59. The asynchronous expansible switching system for switching packet with different length as claimed in claim 51, wherein this packet is unable to be transmitted to the connected output port buffer if the multicast retained device of the switching element is logic 0; if the multicast retained device of the switching element is logic 1 and the output port busy device connected to the switching is in the idle status, then packet is transmitted to the output port buffer connected thereof and the output port busy device is set to be in a busy status.

60. The asynchronous expansible switching system for switching packet with different length as claimed in claim 51, wherein the switching is set to be in the idle status when the unicast packet is transmitted successfully; when the multicast data packet is transmitted successfully, the switching element is set the output port busy device connected thereof to be in the idle status and is set the multicast retained device connected thereof to be in the idle status.
